(19) United States
(12) Patent Application Publication
(10) Pub. No.: US 2012/0327373 A1
(43) Pub. Date: Dec. 27, 2012

(54) SCAN-TYPE IMAGE DISPLAY DEVICE

(76) Inventors: Norio HOSAKA, Yokohama (JP); Eiji Tsubono, Yokohama (JP); Takeshi Nakao, Sagamihara (JP); Fumio Haruna, Fujisawa (JP)

(21) Appl. No.: 13/526,564

(22) Filed: Jun. 19, 2012

(30) Foreign Application Priority Data
Jun. 22, 2011 (JP) 2011-138161

(51) Int. Cl. G03B 21/14

(52) U.S. Cl. 353/31

(57) ABSTRACT

The present invention provides a scan-type image display device. In the scan-type image display device, laser light sources respectively generate light beams of green, red and blue, which in turn are combined by dichroic mirrors to generate a first beam and a second beam. A deflecting mirror device two-dimensionally scans the first and second beams under the rotation of a deflecting mirror thereof. The outgoing directions of the first and second beams have an angular difference relative to the vertical direction of a screen, and an interval between the first and second laser beams is set to be larger than an aperture diameter defined by laser safety standards.

### CLAIM OF PRIORITY

The present application claims priority from Japanese patent application serial No. JP 2011-138161, filed on Jun. 22, 2011, the content of which is hereby incorporated by reference into this application.

### BACKGROUND OF THE INVENTION

(1) Field of the Invention

The present invention relates to a scan-type image display device, and particularly to a scan-type image display device which two-dimensionally scans light beams while rotating a deflecting mirror to thereby project and display an image on a screen or the like.

(2) Description of the Related Art

There has been proposed a scan-type image display device which two-dimensionally deflects light beams (laser beams) emitted from light sources by deflecting means to scan on its screen and projects and displays a two-dimensional image on the screen by residual image effects thereof. Such a scan-type image display device has a configuration in which laser lights of three primary colors (R, G and B) are used for the light sources and combined together, and the combined laser beam scans on the screen through the deflecting means such as a MEMS (Micro Electro-Mechanical Systems) mirror or the like. Since the scanning is performed by the combined single laser beam in this configuration, a scan system can be simplified. Since, however, the laser light is of a parallel light whose divergence angle is small, there is a danger that when a laser beam prior to being applied onto the screen enters into human eyes, the eye's retinas will be burned. Thus, in order to ensure eye safety against the laser, there is provided an upper limit value or accessible emission limit to the power (energy) of the combined single laser beam. As a result, the brightness of a displayed image is limited.

This has been described in JP-A-2005-031529 that with a view toward ensuring safety against a laser beam and brightening up a displayed image, an irradiated laser beam is divided into a plurality of beams, which respectively have a difference in time at approximately the same position and location on a screen and are applied onto the screen, and laser beam intensities at approximately the same location are dispersed and reduced.

There has been described in JP-A-2007-140010, a configuration that has, with a view toward displaying an image using a plurality of beam lights by a simple configuration, a light source unit which supplies a plurality of beam lights, and a scan unit which causes a plurality of light beams incident at incident angles different from one another to be scanned in a first direction and a second direction approximately orthogonal to the first direction.

### SUMMARY OF THE INVENTION

In the safety standards (IEC60825, JISC6802) on laser products, the laser products are classified based on the maximum permissible exposure (MPE). That is, there are defined (1) an accessible emission limit (AEL) of laser beam intensities (single pulses) simultaneously launched into an aperture (equivalent to the pupil diameter of a human eye) having a predetermined size, and (2) an accessible emission limit of laser beam intensities (repetitive pulses) repeatedly incident into an aperture having a predetermined size.

In JP-A-2005-031529, the laser beam is divided into a plurality of pulses, which are applied with a time difference therebetween, thereby making it possible to reduce beam intensities simultaneously incident in an aperture. In the technology described in JP-A-2005-031529, however, when the interval between the divided pluses is shorter than a predetermined time Ti (determined every wavelength band), their pulse groups are assumed to be a single pulse in the standard, and the beam intensities of the pulses are added up, so that the effect that the laser beam has been divided cannot be obtained. For example, assume where the divided beams are arranged with being shifted by an aperture diameter AP or more in a beam scanning direction (high-speed scanning screen horizontal direction in a two-dimensional direction). Assuming that a horizontal scanning frequency fH is 25 kHz, the interval between plural pulses becomes a value (a few μsec) much smaller than a horizontal scan time (1/(2fH)=20 μsec). Therefore, the interval becomes shorter than a predetermined time Ti (Ti=18 μsec when the wavelength ranges from 400 nm to 1050 nm), and hence the divided beams are assumed to be a single pulse. It is thus difficult to more improve safety by beam splitting or enhance beam intensities by a margin against the safety standards, which has been produced by beam splitting and thereby brighten a displayed image.

Incidentally, although JP-A-2007-140010 has disclosed the configuration in which the plural beams are arranged with being shifted in the horizontal direction on the screen and its vertical direction, the safety of the laser beams is not taken into consideration and hence the difference in time therebetween is not determined based on the safety.

With the foregoing in view, the present invention aims to provide a scan-type image display device capable of taking into consideration standards for safety of laser beams to ensure safety and improving brightness of a displayed image.

The present invention provides a scan-type image display device that projects laser beams onto a screen and two-dimensionally scans the same on the screen to display an image, which includes a plurality of laser light sources that generate laser beams of a red light, a green light and a blue light respectively; an optical system which combines the laser beams to generate first and second laser beams; and a deflecting mirror device which two-dimensionally scans the first and second laser beams by rotation of a deflecting mirror thereof. The optical system is set in such a manner that outgoing directions of the first and second laser beams have an angular difference θ relative to a vertical direction of the screen, and a vertical interval d between the first and second laser beams becomes larger than an aperture diameter AP defined by safety standards at a position spaced apart by a distance M defined based on safety standards for the laser beams.

Preferably, the first laser beam is generated by a green light beam, and the second laser beam is generated by a red light beam and a blue light beam.

Alternatively, the first laser beam is generated by a green light beam and a red light beam, and the second laser beam is generated by a green light beam and a blue light beam.

According to the present invention, there can be provided a scan-type image display device capable of ensuring safety for laser beams and improving brightness of a displayed image.

### BRIEF DESCRIPTION OF DRAWINGS

These and other features, objects and advantages of the present invention will become more apparent from the following description when taken in conjunction with the accompanying drawings wherein:

FIG. 1 is a configuration diagram showing a first embodiment of a scan-type image display device according to the present invention;

FIG. 2 is a diagram illustrating a signal control circuit in the first embodiment;

FIG. 3 is a diagram illustrating laser drive signals for laser light sources;

FIG. 4 is a diagram for describing the setting of each blanking period;

FIG. 5 is a diagram for describing an evaluation condition for a laser beam intensity;

FIG. 6 is a diagram showing beam scanning lines that penetrate into an aperture;

FIG. 7 is a diagram illustrating the layout of split beams in the first embodiment;

FIG. 8 is a diagram showing the amounts of light flux (intensity ratio) of R, G and B lights at a white display;

FIG. 9 is a diagram depicting time changes in split beams incident into an aperture;

FIG. 10A is a diagram illustrating one of various beam splitting systems (single beam system);

FIG. 10B is a diagram showing one of the various beam splitting systems (horizontal split);

FIG. 10C is a diagram depicting one of the various beam splitting system (vertical split);

FIG. 10D is a diagram showing one of the various beam splitting systems (vertical split);

FIG. 11A is a diagram illustrating time changes in incident beam in FIG. 10A (single beam system);

FIG. 11B is a diagram depicting time changes in incident beams in FIG. 10B;

FIG. 11C is a diagram showing time changes in incident beams in FIG. 10C;

FIG. 11D is a diagram illustrating time changes in incident beams in FIG. 10D;

FIG. 12 is a diagram showing the effect of increasing the amount of beam light flux by the first embodiment;

FIG. 13 is a configuration diagram illustrating a second embodiment of a scan-type image display device according to the present invention;

FIG. 14 is a configuration diagram showing a third embodiment of a scan-type image display device according to the present invention; and

FIG. 15 is a diagram showing the effect of increasing beam intensities by the third embodiment.

### DESCRIPTION OF THE PREFERRED EMBODIMENTS

Preferred embodiments of the present invention will hereinafter be described using the accompanying drawings.

### First Embodiment

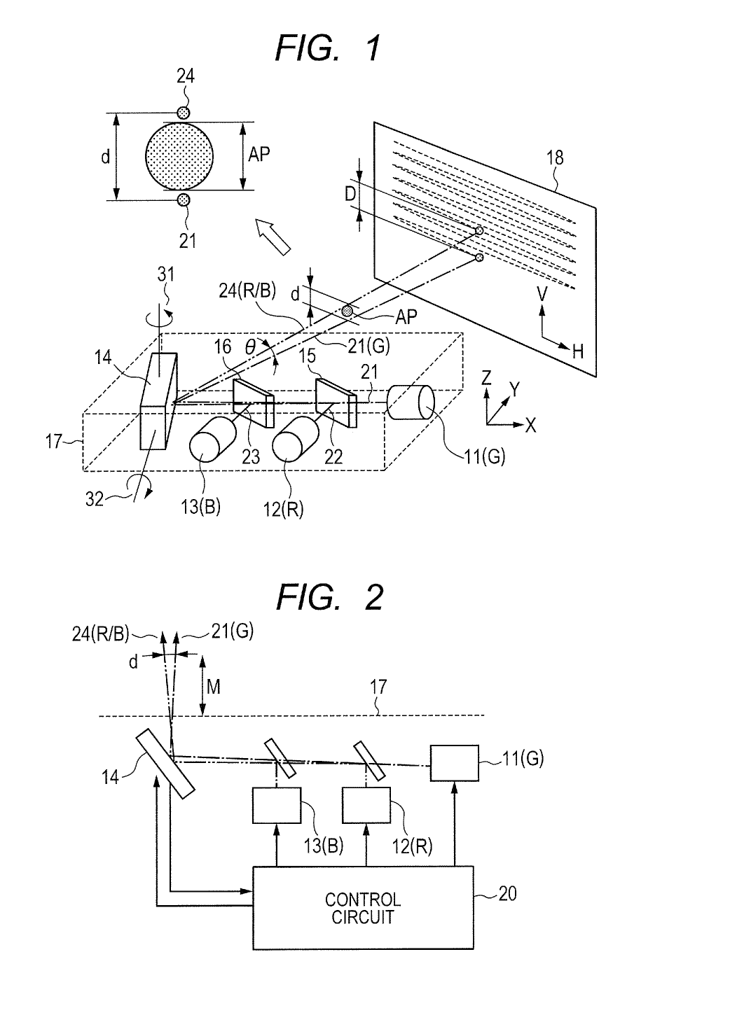

FIG. 1 is a configuration diagram showing a first embodiment of a scan-type image display device according to the present invention. Optical parts to be described below are accommodated in a casing 17. A laser light source 11 emits a green light beam (G light) 21 in a wavelength band of 510 nm, a laser light source 12 emits a red light beam (R light) 22 in a wavelength band of 640 nm, and a laser light source 13 emits a blue light beam (B light) 23 in a wavelength band of 440 nm. The respective light beams 21, 22 and 23 are emitted at intensities corresponding to signals of respective color components in image signals.

A dichroic mirror 15 causes the G light beam 21 to pass therethrough and reflects the R light beam 22. A dichroic mirror 16 causes the G light beam 21 and the R light beam 22 to pass therethrough and reflects the B light beam 23. Of the light beams 21, 22 and 23 penetrated through or reflected by the dichroic mirrors 15 and 16, the G light beam 21 is defined as a single beam (first beam), and the R and G light beams 22 and 23 are combined together (hereinafter described as R/B light), which in turn proceeds as a single beam 24 (second beam). At this time, the first beam 21 and the second beam 24 are set in such a manner that their beam traveling directions are shifted or deviated in the vertical direction from each other by an angular difference θ. In order to achieve the angular difference θ, the tilts and positions of optical axes of the respective laser light sources 11, 12 and 13, and the tilts of the dichroic mirrors 15 and 16 are adjusted. The first beam 21 and the second beam 24 are launched into a deflecting mirror device 14 for light beam scanning.

The deflecting mirror device 14 has one reflecting mirror (deflecting mirror) which reflects the two incident beams 21 and 24, and a drive mechanism which two-dimensionally rotatably drives the deflecting mirror. The deflecting mirror device 14 reflects the incident light beams 21 and 24 and project them on a screen 18 spaced apart by a predetermined distance. The deflecting mirror periodically performs repetitive rotational motion about a rotational axis 31 approximately parallel to a Z axis and a rotational axis 32 approximately parallel to an X-Y plane both shown in the drawing by means of the drive mechanism by predetermined angles (deflection angles) respectively. The deflecting mirror device 14 is configured using, for example, an MEMS mirror, a galvanometer mirror or the like.

Since the two light beams 21 and 24 emitted from the deflecting mirror device 14 are shifted in outgoing direction by the angular difference θ as viewed in the vertical direction, the positions of the beams applied onto the screen 18 are also spaced apart by a distance or interval D as viewed in the vertical direction (V direction). With the deflecting operation of the deflecting mirror device 14, the light beams 21 and 24 are scanned over the screen 18 in the horizontal (H) and vertical (V) directions. At this time, the optical outputs of the laser light sources 11, 12 and 13 are respectively independently modulated in sync with the scan positions of the light beams 21 and 24 on the screen 18, whereby a two-dimensional color image is displayed on the screen 18 using a residual image phenomenon of human eyes.

Thus, in the present embodiment, the light beams projected onto the screen 18 are divided into the first beam (R) 21 and the second beam (R/B) 24, which are applied onto the screen 18 with being shifted by the interval D in the vertical direction, thereby reducing an intensity as a single beam and enhancing the safety against each laser beam. In the present embodiment, with consideration given to an intensity ratio (intensity ratio at the white display) between the R, G and B lights, the G light having the maximum intensity was defined as the first beam 21, and other R and B lights were combined into the second beam 24. Since the magnitude of the interval D between the beams on the screen 18 depends on a projection distance to the screen 18 even though the angular difference θ in the beam outgoing direction is constant, its magnitude cannot be defined uniquely. Thus, based on the fact that the safety standards for the laser beams is evaluated on the basis of the intensity of each beam that penetrates through an aperture having a predetermined size at a position spaced apart from a beam outgoing port by a predetermined distance M (100 mm), the interval d between the two beams 21 and 24 is laid out to be greater than an aperture diameter AP at the position spaced apart from the beam outgoing position by the predetermined distance M.

FIG. 2 is a diagram showing a signal control circuit in the scan-type image display device according to the present embodiment. The control circuit 20 transmits control signals for output timings of image signals and a blanking processing signal to the respective laser light sources 11, 12 and 13 respectively. In response to a position detection signal of the deflecting mirror device 14, the control circuit 20 sends a control signal for repeatedly rotating the deflecting mirror in the horizontal and vertical directions in sync with the image signal.

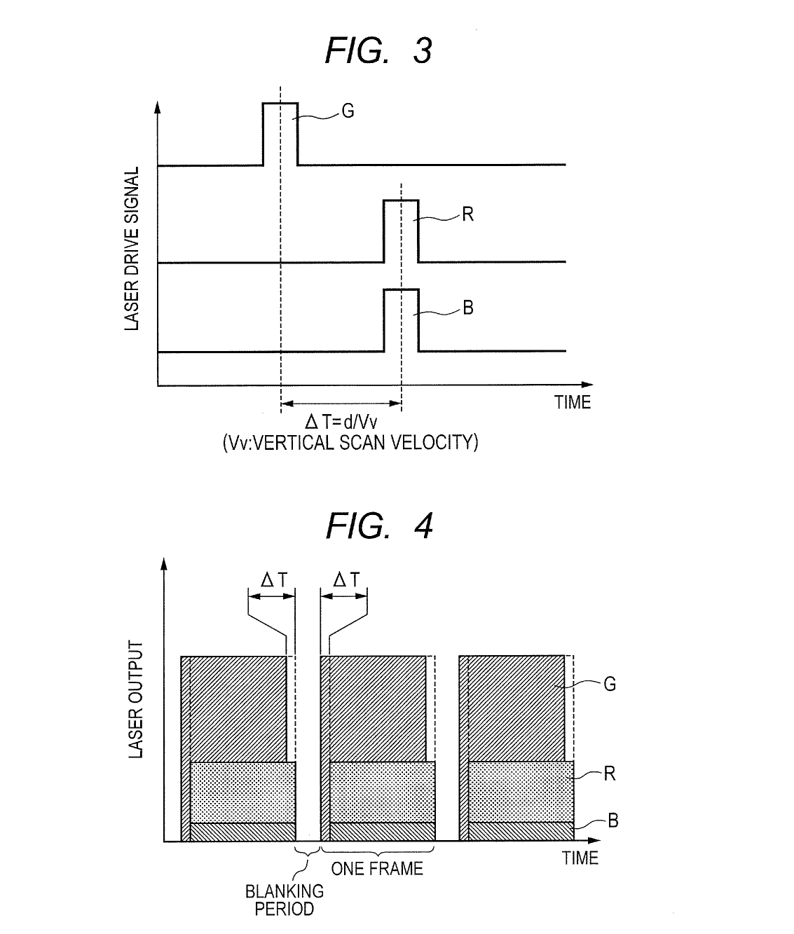

FIG. 3 is a diagram showing laser drive signals relative to the respective laser light sources. The present drawings shows output timings of each of R, G and B signals at the time that one point lying on the screen is irradiated with each beam. A beam deviation in the vertical direction at a position spaced apart from the beam outgoing port by a predetermined distance M (100 mm) is defined as d, and the scan velocity in the vertical direction is defined as Vv. When the first beam 21 (G light) is scanned in the vertical direction prior to the second beam 24 (R/B light), the R and B signals are outputted with their timings being delayed by a time difference ΔT=d/Vv with respect to the G signal. As a result, no temporal deviation (color discrepancy) occurs in each of the R, G and B signals displayed at one point on the screen.

FIG. 4 is a diagram for describing the setting of a blanking period. An image display based on the beam two-dimensional scanning has a period (blanking period) during which a beam scanning position is returned from the lower end of the screen to its upper end for the purpose of frame switching. During that period, the image display (signal output) is stopped. Further, in the present embodiment, since the beams are split and arranged with being deviated in the vertical direction, there occurs an ineffective region (equivalent to a difference in time ΔT) in which one of the beams is not applied to the upper and lower ends of the screen. Therefore, a process including the above blanking period is performed on this region to avoid image artifacts at the upper and lower ends of the screen.

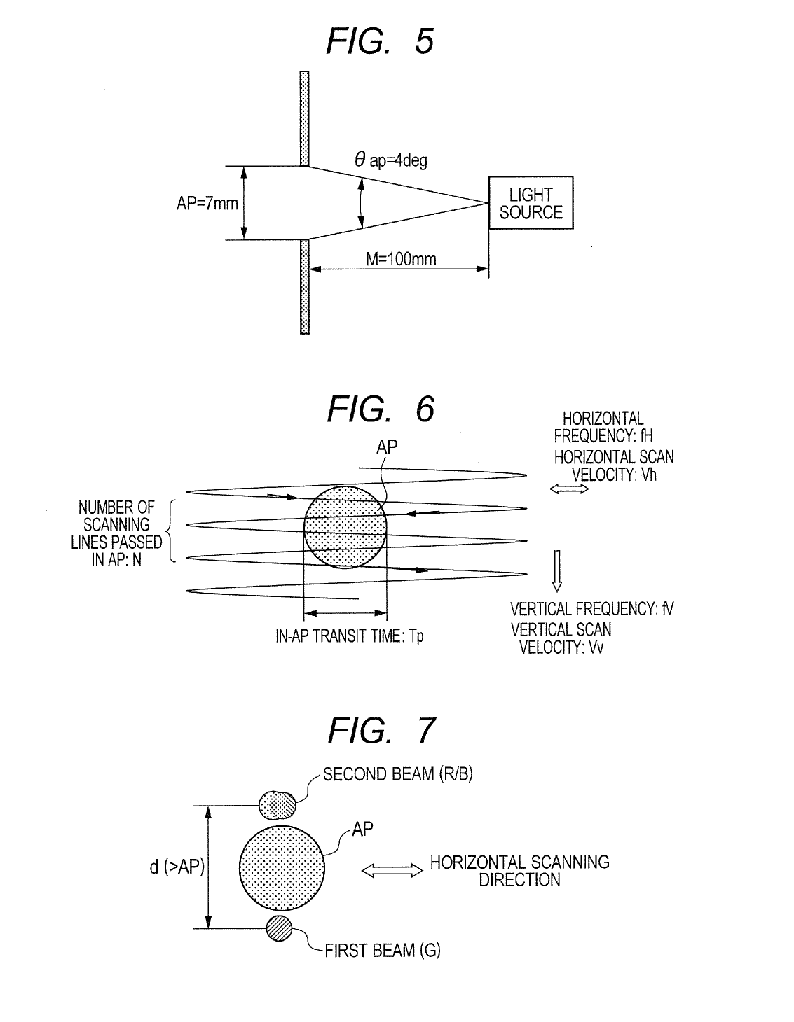

FIG. 5 is a diagram for describing evaluation conditions for the intensity of a laser beam. In safety standards for the laser beam, it is evaluated at the intensity of the beam that passes through an aperture diameter AP (7 mm) at a position spaced apart from a laser light source (or device's outgoing port) by a distance M (100 mm). This size AP is equivalent to the pupil diameter of a human being. A line-of-sight angle to an aperture as viewed from the light source becomes θap=4 degs. The beams incident into this AP simultaneously are brought into a single beam (single pulse), and an accessible emission limit (AEL) is defined with respect to its intensity.

FIG. 6 is a diagram showing beam scanning lines that passes through the aperture. Beam scanning is performed using a horizontal scan (frequency fH=25 kHz) reciprocated from side to side, and a vertical scan (frequency fV=60 Hz). The number N of scanning lines passing through the aperture diameter AP per vertical scan is determined by the number of vertical scanning lines Nv, a vertical scan angle θv and a line-of-sight angle θap relative to the aperture. When, for example, Nv=768, θv=36 degs, and θap=4 degs, the number of passed scanning lines N=86. If a horizontal scan angle θh=46 degs, the time Tp taken when one scanning line cuts across the aperture becomes 0.956 μsec in the center of the screen.

FIG. 7 is a diagram showing the layout of divided beams in the present embodiment. The post-division first beam (G) and second beam (R/B) are placed in positions apart from the beam outgoing port by a distance M with being shifted or deviated in the vertical direction by an interval d larger than an aperture diameter AP. In other words, the difference θ in angle between the two outgoing beams as viewed in the vertical direction is set larger than the line-of-sight angle θap (4 degs) relative to the aperture. The beam pair is scanned in the horizontal direction while holding this interval d (or angular difference θ). As a result, the two beams are not simultaneously launched into the aperture. Although the first beam (G) is laid out ahead of the second beam (R/B) as viewed in the vertical direction (placed below the second beam), the second beam (R/B) may be arranged ahead of the first beam (G). In such a case, the output timings of the signals shown in FIG. 3 may be set in reverse.

FIG. 8 is a diagram showing the amounts of light flux of R, G and B lights (intensity ratios) outputted from the laser light sources upon the white display. The maximum G light (510 nm) is given as 67.7%, R light (637 nm) is next given as 30.8%, and the minimum B light (445 nm) is given as 1.5%. Incidentally, the intensity ratio is slightly shifted depending on the selection of wavelengths to be used. In view of a balance between beam intensities after beam splitting, the simplest splitting method is provided which sets the G light having the maximum intensity as a first beam and combines other R and B lights together to form a second beam.

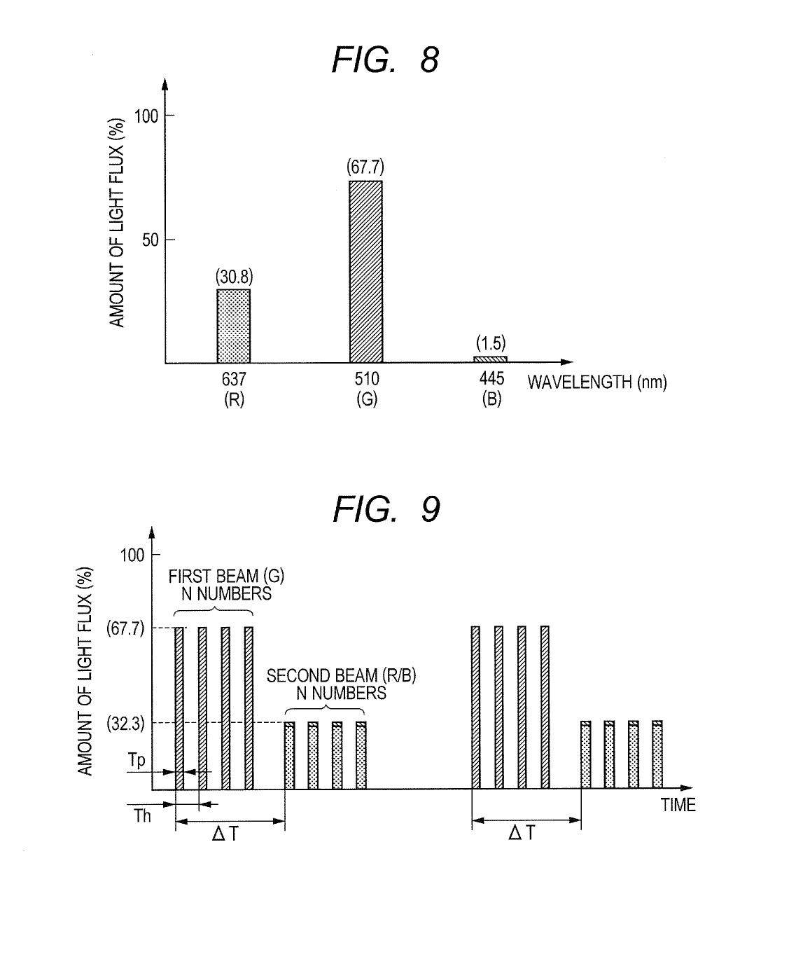

FIG. 9 is a diagram showing time changes in split beams incident into the aperture. First, a train of pulses of a first beam (G) is launched into the aperture as N (e.g. 86) in number. Each pulse has a time width Tp=0.956 μsec and an interval Th=20 μsec. After these pulse trains, a train of pulses of a second beam (R/B) is launched into the aperture by N in number. The train of pulses of the second beam is similar to the first beam in terms of a time width Tp and an interval Th. Since the vertical interval d between the first and second beams is set larger than the aperture diameter AP at this time, a difference in time ΔT between starting of incidence of the two becomes larger than the time during which all the pulses of the first beam pass. The trains of pulses of the first and second beams do not overlap in time even at their parts.

With such a beam split, the maximum value of each of the single pulses simultaneously incident into the aperture is reduced to an amount of light flux 67.7% at the incidence of the first beam (G), thus enhancing safety against the laser beams. Incidentally, since the interval between the pulse trains is Th (20 μsec) and longer than a predetermined time Ti (18 μsec) defined with respect to a repetitive pulse, there is no occurrence that the beam intensities are added up and assumed to be the single pulse, and hence the beam split becomes effective.

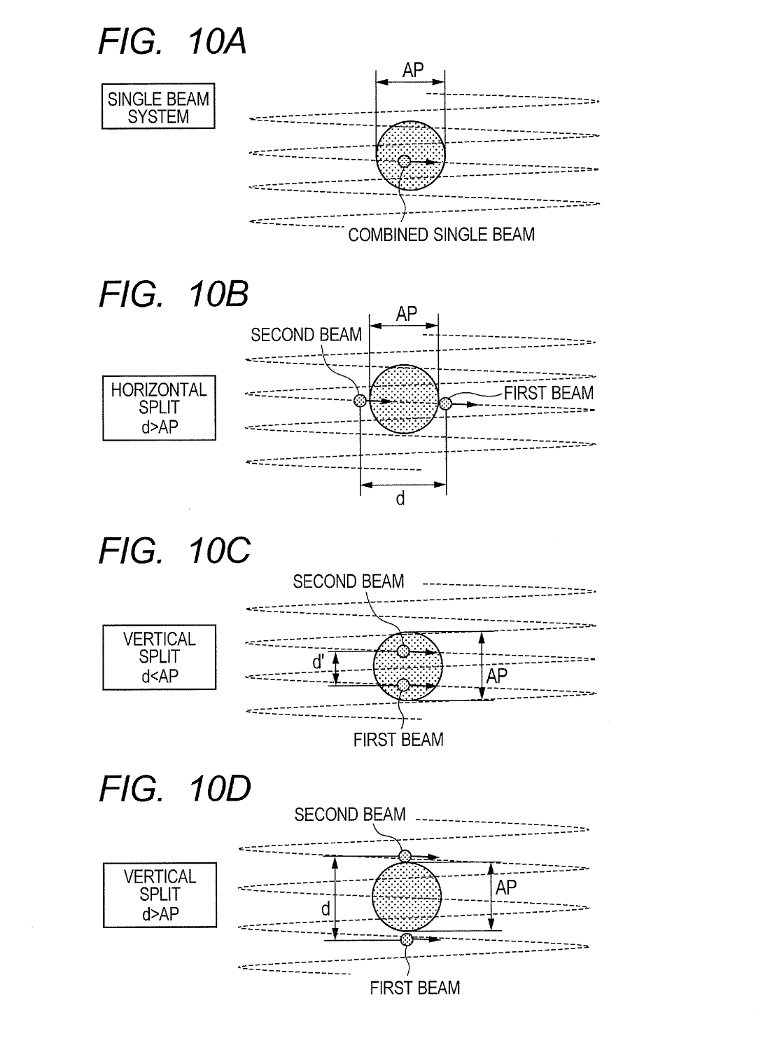

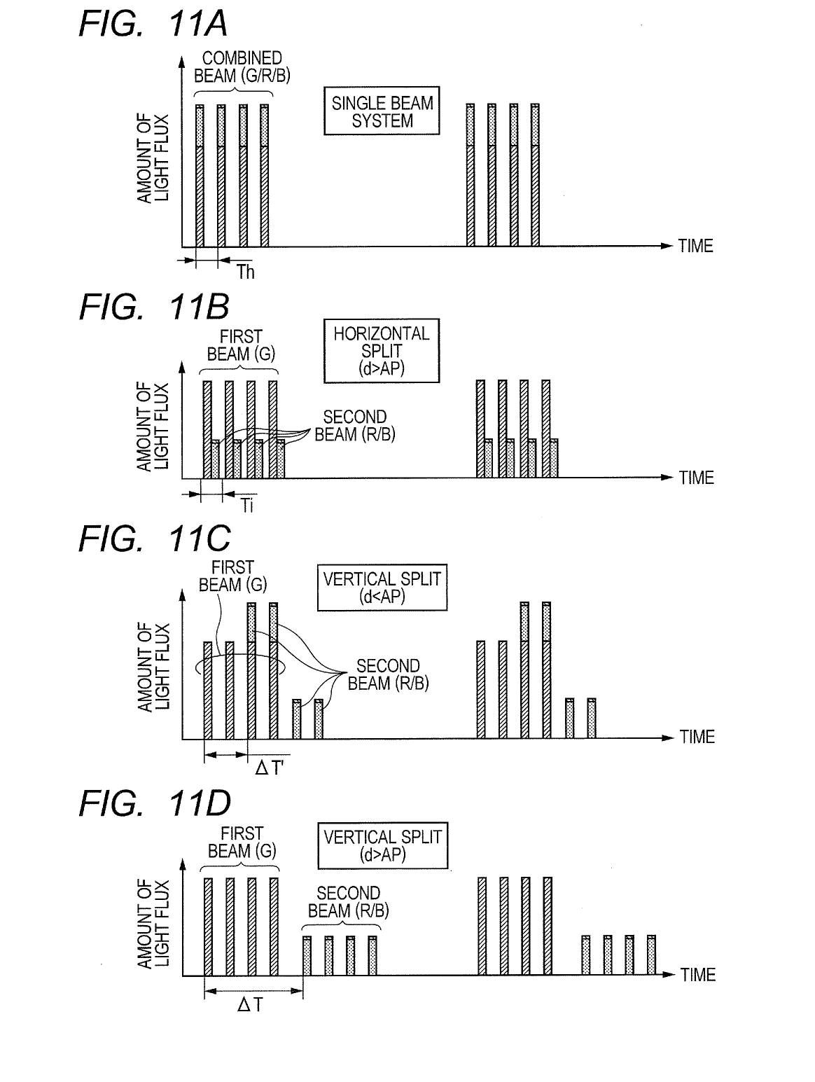

Superiority of the beam split system according to the present embodiment will next be explained in comparison with the others. FIGS. 10A through 10D and FIGS. 11A through 11D are respectively diagrams showing relationships between various beam split systems and time changes in incident beams relative thereto. Of these, FIGS. 10D and 11D correspond to the present embodiment.

FIG. 10A and FIG. 11A respectively show a conventional single beam system in which all of R, G and B are combined together to form one beam. Since the intensity of a single pulse has an upper limit value or accessible emission limit, it is impossible to increase the total amount of light flux.

FIG. 10B and FIG. 11B respectively show a horizontal split system where a first beam and a second beam are arranged with being spaced apart from each other in a horizontal direction by an interval d larger than an aperture diameter AP. In this case, the two beams are not launched into the aperture simultaneously. Since, however, the adjacent two pulses (first and second beams) are close to each other and included in the predetermined time Ti (18 μsec), they are assumed to be a single pulse and their intensities are added together. As a result, this system leads to the same treatment as the single beam system shown in FIGS. 10A and 11A.

FIG. 10C and FIG. 11C respectively show a vertical split system but correspond to the case where first and second beams are placed in a vertical direction with being spaced apart from each other by an interval d′ smaller than the aperture diameter AP. Since a difference in time ΔT′ between starting of incidence of the first and second beams becomes short in this case, a pulse train of the second beam enters before all trains of pulses of the first beam do not pass, thus causing a their overlap in time. That is, there occurs a period during which the two beams are simultaneously launched into the aperture. Eventually, the present vertical split system is subjected to the same treatment as the single beam system shown in FIGS. 10A and 11A.

FIG. 10D and FIG. 11D respectively show a vertical split system and correspond to the case in which first and second beams are arranged in a vertical direction with being spaced apart from each other by an interval d larger than an aperture diameter AP. As described in FIG. 9, the two beams are not simultaneously launched into the aperture. Further, since the interval between the adjacent pulses is always longer than the predetermined time Ti, they are not assumed to be a single pulse. It is thus possible to reliably reduce the beam intensity of the single pulse by the beam split.

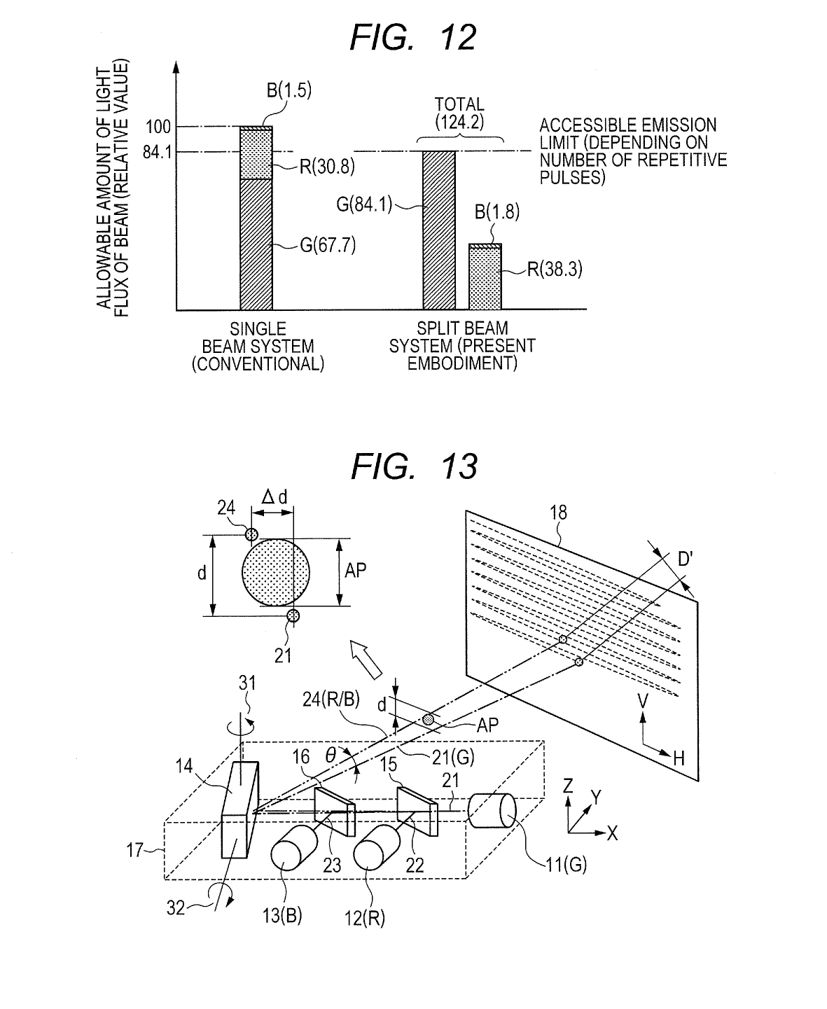

FIG. 12 is a diagram showing the effect of increasing the amount of light flux by the present embodiment. The vertical axis indicates the allowable amount of light flux of a laser beam (relative value), which is determined from the accessible emission limit for the safety standards. Since the number of repetitive pulses increases twice in the split beam system assuming that the accessible emission limit of the conventional single beam system is 100, the accessible emission limit (AEL) is reduced to 84.1 where a correction on its increase is performed. When the amount of light flux of the first beam (G) is set so as to use up to the accessible emission limit 84.1, and the second beam (R/B) is assigned in the intensity ratio shown in FIG. 8 in matching with its setting, the R light is brought to 38.3 and the B light is brought to 1.8. As a result, the total or sum of amounts of outgoing light flux of laser beams can be increased to 124.2 and hence the brightness of a displayed image can be improved.

### Second Embodiment

FIG. 13 is a configuration diagram showing a second embodiment of a scan-type image display device according to the present invention. The present embodiment is similar in basic configuration to the first embodiment (FIG. 1), but related to the case where when divided first and second beams 21 and 24 are arranged in a vertical direction with their position being shifted or deviated by an interval d, they are deviated even in a horizontal direction by Δd. As a result, the positions of the beams projected onto the screen 18 deviate in an oblique direction by D′. Although, when the deviation Δd in the horizontal direction exists, it is undesirable because there occurs a region in which one beam is not applied at the right and left ends of a display screen, a slight deviation Δd may remain even depending on adjustments in optical system (laser light sources 11, 12 and 13 and dichroic mirrors 15 and 16).

In this case, the control circuit 20 shown in FIG. 2 corrects the output timings of image signals of the first and second beams 21 and 24 by causing the same to deviate from each other by a time equivalent to Δd. That is, the control circuit 20 applies a time difference ΔT=d/Vv+Δd/Vh (Vh: horizontal scan velocity) to each of the laser drive signals shown in FIG. 3. As a result, a deviation in time (color discrepancy) does not occur in each of R, G and B signals displayed on the screen.

### Third Embodiment

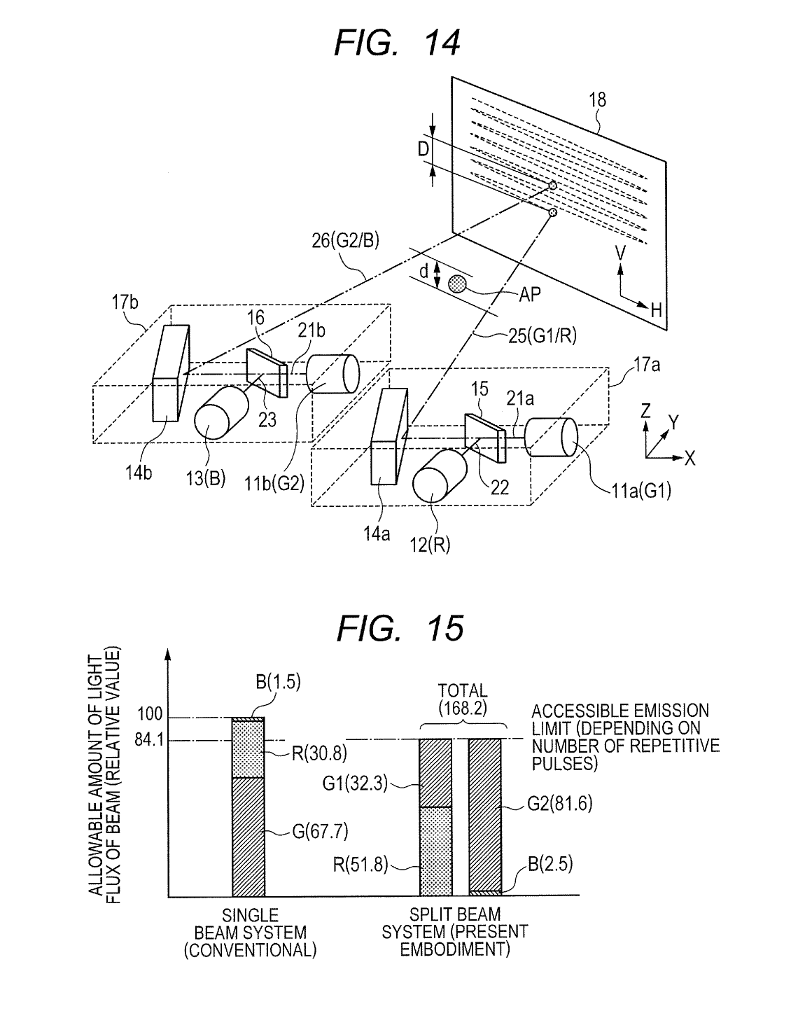

FIG. 14 is a configuration diagram showing a third embodiment of a scan-type image display device according to the present invention. In the present embodiment, a laser beam splitting method is changed, which splits a G light into a G1 light and a G2 light and generates a first beam obtained by combining the G1 light and an R light and a second beam obtained by combining the G2 light and a B light. That is, the G light large in beam intensity ratio is split into two and thereby the intensities (amounts of light flux) of the first and second beams are matched with each other.

The scan-type image display device is equipped with two casings (optical systems). The casing 17a has a laser light source 11a for the G1 light and a laser light source 12 for the R light. A G1 light beam 21a and an R light beam 22 are combined to form a first beam (G1/R) 25, which in turn is reflected by a first deflecting mirror device 14a and projected onto a screen 18. The casing 17b has a laser light source 11b for the G2 light and a laser light source 13 for the B light. A G2 light beam 21b and a B light beam 23 are combined to form a second beam (G2/B) 26, which in turn is reflected by a second deflecting mirror device 14b and projected onto the screen 18. The outgoing directions of the first beam 25 and the second beam 26 are deviated in a vertical direction as with the first embodiment by adjusting the positions of the optical systems. That is, the two beams are arranged so as to be spaced apart from each other by an interval d in the vertical direction at a position apart from each beam outgoing position by a predetermined distance M (100 mm). This interval d is set larger than an aperture diameter AP (7 mm).

FIG. 15 is a diagram showing the effect of increasing beam intensities by the present embodiment. The vertical axis indicates the allowable amount of light flux of a laser beam. Assuming that the accessible emission limit of the conventional single beam system is 100, the accessible emission limit becomes 84.1 in a split beam system where the number of repetitive pulses is corrected. The amounts of light flux of the first beam (G1/R) and the second beam (G2/B) are both set to use up to the accessible emission limit 84.1. When the amounts of light flux of color or chromatic lights are assigned at the intensity ratios shown in FIG. 8, the G1 light becomes 32.3, the G2 light becomes 81.6, the R light becomes 51.8 and the B light becomes 2.5. As a result, the total amount of light flux of the laser beams can be increased to 168.2, and the brightness of a displayed image can further be improved.

According to each of the above-described embodiments, laser beams projected onto the screen are split into a first beam and a second beam, which in turn are arranged with being spaced by an interval d in the vertical direction. The interval d is set larger than an aperture diameter AP defined by the laser beam safety standards to thereby avoid the simultaneous incidence of the two beams into an aperture, so that the beam intensity of a single pulse can be reduced. Since the time intervals of the first and second beams incident into the aperture are longer than a predetermined time Ti defined by standards, they are assumed to be a single pulse and the beam intensities of the two are not added up. It is thus possible to improve safety by reducing the beam intensity of the single pulse. Further, a margin of safety is provided against a safety standard (allowable value) with the reduction in the beam intensity of the single pulse. Thus, the brightness of a displayed image can be enhanced by increasing the total amount of beam light flux.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A scan-type image display device which projects laser beams onto a screen and two-dimensionally scans the same on the screen to display an image, comprising:
a plurality of laser light sources which generate laser beams of a red light, a green light and a blue light respectively;
an optical system which combines the laser beams to generate first and second laser beams; and
a deflecting mirror device which two-dimensionally scans the first and second laser beams by rotation of a deflecting mirror thereof,
wherein the optical system is set in such a manner that outgoing directions of the first and second laser beams have an angular difference θ relative to a vertical direction of the screen, and a vertical interval d between the first and second laser beams becomes larger than an aperture diameter AP defined by safety standards at a position spaced apart by a distance M defined based on safety standards for the laser beams.

2. The scan-type image display device according to claim 1, wherein the first laser beam is generated by a green light beam, and the second laser beam is generated by a red light beam and a blue light beam.

3. The scan-type image display device according to claim 1, wherein the first laser beam is generated by a green light beam and a red light beam, and the second laser beam is generated by a green light beam and a blue light beam.

4. The scan-type image display device according to claim 1, comprising a control circuit which causes image signals of the first laser beam and the second laser beam to be outputted with their timings being shifted by a time difference ΔT necessary to scan the interval d in the vertical direction.
